(19) United States
(12) Patent Application Publication
(10) Pub. No.: US 2012/0132444 A1
(43) Pub. Date: May 31, 2012

(54) Dry Sprinkler head

(75) Inventors: Mirko Buzdum, Watertown, WI (US); Richard Capstran, Milwaukee, WI (US)

(73) Assignee: CAPPY'S CONCEPTS LLC

(21) Appl. No.: 12/927,935

(22) Filed: Nov. 29, 2010

(51) Int. Cl. A62C 35/62

(52) U.S. Cl. 169/17

(57) ABSTRACT

A dry sprinkler head which comprises a fail safe seat, and is fully adjustable.

### FIELD OF THE INVENTION

The present invention relates to a dry sprinkler head which comprises a fail safe seat, and can be fully adjustable.

### BACKGROUND OF THE INVENTION

Many, if not all, fire codes require certain types of buildings, structures and areas to be equipped with a safety system used to prevent the spread of fires. Such fire protection systems commonly utilize a network of sprinkler pipes for conducting a fire extinguishing medium, such as water, to a plurality of automatic sprinklers which may be arranged vertically, either in a pendent position or an upright position, or horizontally. Two common types of automatic sprinkler systems are the wet pipe type and the dry pipe type.

According to the standard for the Installation of Sprinkler Systems, NFPA 13, a sprinkler system is defined as an integrated system of underground and overhead piping designed in accordance with fire protection engineering standards. The installation includes one or more automatic water supplies. The portion of the sprinkler system above ground is a plurality of specially sized or hydraulically designed piping installed in a building, structure, or area, generally overhead, and to which sprinklers are attached in a systematic pattern. The valve controlling each system riser is located in the system riser or its supply piping. Each sprinkler system riser includes a device for actuating an alarm when the system is in operation. The system is usually activated by heat from a fire and discharges a fire-retardant substance such as water over the fire area.

The most common type of sprinkler system is a wet pipe sprinkler system. A wet pipe sprinkler system employs automatic sprinklers attached to a piping system containing water and connected to a water supply so that water discharges immediately from sprinklers opened by heat from a fire. This type of system is the simplest and most reliable. However, in areas where the sprinkler system, in whole or in part, is subject to freezing conditions, water cannot be maintained in the sprinkler system piping since it could freeze and compromise the integrity of the system.

The traditional way of providing fire sprinkler protection in these areas is by the use of an antifreeze system, dry pipe sprinkler system and/or dry sprinklers. In wet pipe systems, the sprinkler pipes are filled with a fire extinguishing medium usually water, and connected to an ample supply of the fire extinguishing medium. Individual sprinkler heads are normally closed, but are designed to open, for instance by the melting of an alloy insert, when the ambient temperature reaches a predetermined value, commonly in the neighborhood of 135.degree.-165.degree. F.

If the system piping is subjected to freezing temperatures, for instance, in unheated buildings, such as warehouses, it may be necessary to employ a dry pipe system, rather than a wet pipe system, to prevent the fire extinguishing medium from freezing in the sprinkler pipes. In dry pipe systems, the sprinkler pipes contain a gas, such as air, rather than a fire extinguishing medium. An ample supply of the fire extinguishing medium is connected to the system by a dry pipe valve, which opens in response to the opening of individual sprinkler heads to permit the gas to escape from the sprinkler pipes and water to enter them and discharge from the sprinkler heads.

Dry automatic sprinklers are known which permit the concealment of dry pipe systems and the extension of sprinkler protection to unheated areas from wet pipe systems. Such sprinklers normally have a valve mechanism at the inlet of a nipple which connects an individual sprinkler head to a supply pipe. When the sprinklers are installed in the supply pipe, the valve mechanism extends into the supply pipe, sealing off the nipple until the sprinkler is activated.

A dry pipe sprinkler system is one in which water is prevented from entering the sprinkler system piping until a fire situation has occurred. A dry pipe sprinkler system includes a dry pipe valve which is installed between a water supply and piping of the sprinkler system. The sprinkler system side of the dry pipe valve is pressurized with a gas such as air or nitrogen. This pressure holds the dry pipe valve closed preventing water from entering the system. When a sprinkler activates, the gas pressure drops in the sprinkler system. When the gas pressure drops to a level such that it can no longer hold the dry pipe valve closed, the valve opens and allows water to enter the entire piping system. When a sprinkler system is exposed only to local freezing conditions, such as a freezer, a dry sprinkler is typically used to provide fire protection to that area.

The typical construction of a dry sprinkler is a sprinkler head that is permanently mounted on the end of a length of pipe opposite the inlet end of the pipe. A fusible element or frangible glass bulb is located in the sprinkler frame and is in contact with a strut, rod or tube. The strut, rod or tube transfers the force required to hold in place a seal that is located at the inlet end of the pipe. The seal prevents water from entering the pipe until the sprinkler has operated. Some dry sprinkler designs utilize a pressurized gas filled pipe instead of a strut, rod or tube to transfer the load to the seal inlet from the sprinkler head. In the event of a fire situation, the fusible element or frangible glass bulb activates, releasing the force holding the seal in place and allowing water to flow through the dry sprinkler pipe and out the sprinkler head.

When the dry sprinkler is installed into the sprinkler piping system, the sprinkler head of the dry sprinkler will be located inside the area where the freezing conditions will occur. The pipe, which makes up the length of the dry sprinkler, is kept dry by the seal located at the inlet of the dry sprinkler. This prevents the pipe from filling up with liquid and freezing. The inlet of the dry sprinkler is connected to the sprinkler piping system. The length of the dry sprinkler can vary depending on the location of the sprinkler system with respect to the location of the head of the sprinkler.

The benefits derived from using a conventional dry sprinkler is based essentially on an economical solution to fire protection of a local area that is subject to freezing conditions without the need for a complete dry pipe sprinkler system. The disadvantages of using a conventional dry sprinkler is that it varies in size and currently is made to order by a dry sprinkler manufacturer. The current manner of installing dry sprinklers is to initially measure the distance from the sprinkler piping system to the locations that the sprinklers will be employed. Subsequently, a list is made of the location and size of each dry sprinkler required for a given installation. An order for these dry sprinklers is then placed with a dry sprinkler manufacturer. Completion of the installation then waits for the manufacturer to produce and send them to the contractor. In essence, the process for installing conventional dry sprinklers is time consuming. In addition, unlike a wet pipe system, the length of a pipe nipple in a dry sprinkler cannot be adjusted in the field by the sprinkler fitter. If the contractor orders the wrong size or the manufacturer fabricates the wrong size, another order must be issued, which further delays the installation time.

Dry sprinklers are used where the sprinklers may be exposed to freezing temperatures. A dry sprinkler typically includes a threaded inlet containing a plug, some length of tubing connected to the threaded inlet, and sprinkler components (e.g., a frame, deflector and thermally responsive component) located at the other end of the tubing. There also is some connecting mechanism that is located within the tubing and connects the thermally responsive component to the plug. The threaded inlet is at a location that is not subjected to freezing conditions. In some dry sprinklers, when the thermally responsive component releases, the plug is expelled from the sprinkler system by water pressure. In some other dry sprinklers, the plug is moved along the longitudinal tube axis a sufficient distance to clear the inlet opening and permit water flow around the sides of the plug.

Dry sprinklers are longer than wet sprinklers. Dry sprinklers can be in service for approximately 100 years. A paper mill can have a temperature which varies between 100° and −40° F. Dry sprinklers use a bulb which is sensitive to heat. There is fluid in a vial which expands upon heating. Somewhere between 135° and 500° the size of the vial changes before it shatters.

There are three types of dry sprinklers, uprights, pendent and sidewalls. There is condensation in a sprinkler system. A dry sprinkler prevents the condensation from collecting and freezing in the sprinkler head and facilitates draining.

A dry sprinkler has a compression seat. Metal is compressed on metal. There is a spring forced against the seat. The pressure on the seat typically exceeds 300 PSI. Two metals in contact with that much pressure can fuse together. Approximately 60-80% of prior art dry sprinklers fail.

Encapsulated seats are encapsulated in Teflon. As water pressure fluctuates, or buildings move, Teflon coatings wear off. Springs are very restrictive.

Sprinkler systems are designed for hydraulic flow. Sufficient pressure and flow are required to wet the entire square footage of a building. One can either enlarge the pipe sizing, install a fire pump, or increase the orifice size, or “K” factor to achieve the necessary flow and pressure.

U.S. Pat. No. 5,099,925 relates to a dry sprinkler system which includes a compressed gas pilot operated water valve between a water supply main and a dry sprinkler pipe, the valve being normally open and held closed upon activation of the pilot by water pressure

U.S. Pat. No. 5,188,185 relates to a dry sprinkler for mounting on a piping system in a fire protection installation including an outer tube structure having an inlet end with an inlet opening, an outlet end having an outlet opening, and a tube axis that passes through the inlet opening and along the tube structure, a connecting structure that is mounted for movement along the axis within the tube structure, a thermally responsive component supported by the tube structure at the outlet end and supporting the connecting structure under normal temperature conditions and releasing the connecting structure during abnormal temperature conditions to permit it to move, a seal member that is caused by the connecting structure to seal the inlet opening when the connecting structure is supported by the thermally responsive component, the seal member being constrained to move towards one side of the tube axis when the connecting structure is released in order to provide a relatively large unobstructed flow area to permit passage of foreign matter on the other side of the axis.

U.S. Pat. No. 5,775,431 relates to a dry sprinkler having a tube-like section with a sprinkler head at one end and a threaded portion to be received in a water supply line at the opposite end and it includes an internal support structure extending between a sealing plug in the end to be received in the water supply line and a cap in the sprinkler head which is supported by a thermally responsive structure. In one embodiment, the support structure includes a rod on which the sealing plug is mounted at one end and having a cap-engaging tip at the opposite end which is shaped to facilitate the flow of water from the sprinkler head toward a deflector, the rod being spaced from the tube-like section by two guide members, one of which acts as a stop for motion of the structure toward the sprinkler head and the other which engages a spring urging the structure toward the sprinkler head. In other embodiments, a spacer is inserted between the end of the rod and the cap in the sprinkler head and a separate rod tip may be inserted between the rod and the spacer.

U.S. Pat. No. 6,715,561 relates to a vacuum dry sprinkler system which includes a sprinkler head formed with a body having a central orifice through which fire extinguishing fluid is expelled through an outlet end. A yoke, attached to the exterior surface of the sprinkler body, extends beyond the outlet end of the sprinkler body and is connected at its apex to a deflector. A thermally sensitive trigger member is coupled to the yoke and the outlet end of the sprinkler head. The sprinkler body carries an expulsion assembly which includes an expulsion member and a thrust member. In response to a fire, the expulsion member of the expulsion assembly overcomes the vacuum force and expels the sealing assembly out of the outlet end of the sprinkler body, while the thrust member laterally thrusts the sealing member out of the water trajectory path, and thus, prevents the sealing assembly from reseating on the outlet of the sprinkler head.

U.S. Pat. No. 7,802,628 relates to a dry sprinkler for a fire protection system. The preferred dry sprinkler has a metallic disc annulus positionable within a passageway to skew a central axis of a face of the metallic disc annulus with respect to a longitudinal axis of the dry sprinkler so that an expected minimum flow rate based on a rated discharge coefficient is provided. The dry sprinkler operates to provide an expected flow rate over a range of start pressures. The expected flow rate is based on a K-factor rating. The dry sprinkler provides an acceptable level of fluid flow rate from the expected flow rate based on the K-factor for a range of start pressures.

US patent publication 20050121206 relates to a sprinkler assembly for controlling a fire situation which includes at least one fluid conduit defining a flow passage including an inlet for receiving a fluid from a fluid source and at least one outlet for discharging the fluid, and a dispensing mechanism such as an open or closed sprinkler head for distributing water to a selected location. A fluid control apparatus is provided including a valve assembly having a valve seal which is moveable between a closed position blocking fluid flow through the conduit and an open position causing fluid flow through the conduit. The fluid control apparatus further includes an actuating mechanism including a valve actuator which is operatively connected to the valve assembly for causing movement of the valve seal to the open position upon release of the sealing force. A sensing mechanism is operatively connected to the valve assembly, the sensing mechanism being thermodynamically responsive to at least one of heat, smoke, infrared radiation and ultraviolet radiation emitted by a heat source.

US patent publication 20070187116 relates to a dry pipe sprinkler assembly including a sprinkler body having a thermally responsive trigger mounted thereto. A housing, including an inlet end and an outlet end is provided with the outlet end being connected to the sprinkler body. A seal member is disposed at the inlet end of the housing, and a load mechanism extends between the thermally responsive element and the seal member. The load mechanism may include a support portion, a passage tube portion, and an outlet orifice portion slidably received within the housing and movable within the housing upon activation of the thermally responsive trigger to allow the seal member to be dislodged from the inlet end of the housing to allow suppressant fluid to flow therethrough. The dry pipe sprinkler assembly allows the use of different outlet orifice members to provide dry pipe sprinkler assemblies having different K factors while utilizing common components for the remaining dry pipe sprinkler assembly.

US patent publication 20090211772 relates to a dry sprinkler that includes a structure, a fluid deflecting structure, a locator, a metallic annulus and a shield. The structure defines a passageway extending along a longitudinal axis between an inlet and an outlet. The structure has a rated K-factor defining an expected flow of fluid in gallons per minute from the outlet divided by the square root of the pressure of the flow of fluid fed into the inlet of the passageway in pounds per square inch gauge. The fluid deflecting structure is proximate the outlet. The locator is movable along the longitudinal axis between a first position and a second position. The locator supports the metallic annulus. The metallic annulus includes first and second metallic surfaces spaced apart along the longitudinal axis between an inner and outer circumference with respect to the longitudinal axis. The shield has a first face exposed to the inlet and a second face confronting the first metallic surface to define a gap there between.

US patent publication 20090294138 relates to a dry pipe sprinkler assembly including a sprinkler body having a thermally responsive trigger mounted thereto. A housing, including an inlet end and an outlet end is provided with the outlet end being connected to the sprinkler body. A seal member is disposed at the inlet end of the housing, and a load mechanism extends between the thermally responsive element and the seal member. The load mechanism may include a support portion, a passage tube portion, and an outlet orifice portion slidably received within the housing and movable within the housing upon activation of the thermally responsive trigger to allow the seal member to be dislodged from the inlet end of the housing to allow suppressant fluid to flow therethrough. The dry pipe sprinkler assembly allows the use of different outlet orifice members to provide dry pipe sprinkler assemblies having different K factors while utilizing common components for the remaining dry pipe sprinkler assembly.

US patent publication 20100038099 relates to a horizontal dry fire protection sprinkler which includes a housing having a vertical segment and a horizontal segment extending generally perpendicular to the vertical segment. The vertical segment defines an inlet opening. A plug member is disposed in the inlet opening for sealingly closing the inlet opening. A sprinkler is attached to the horizontal segment and includes a base having a passage extending therethrough and defining an outlet opening. A cap is disposed in the outlet opening and a heat sensitive trigger engages the cap. A translation mechanism is disposed in the housing and engaging the cap and supporting the plug member in the inlet opening, wherein when the heat sensitive trigger releases support of the cap, the translation mechanism is allowed to move within said housing to allow the plug member to dislodge from the inlet opening.

### SUMMARY OF THE INVENTION

The present invention relates to a dry sprinkler having a fail safe seat.

The present invention relates to a dry sprinkler comprising a device having an orifice through it. The device is placed in a seat. The device has a groove or notch in it. The dry sprinkler further comprises a rod or actuator linkage wherein the rod or actuator linkage is held in place by the grove or notch of the device. A vial expands and breaks based upon temperature of the surrounding environment. The vial sits in a bulb seat and the rod or actuator linkage is attached to the bulb seat.

It is an object of the present invention for the device to comprise a ball with an orifice through it. It is an object of the present invention for the ball to be placed in an end assembly. It is an object of the present invention for the end assembly to have an inlet ring. It is an object of the present invention for the inlet ring to be made of brass. The ball replaces the compression seat and spring assembly of the prior art.

It is an object of the present invention for the ball to have a groove in it. It is an object of the present invention for the groove to hold a rod or actuator linkage in place. It is an object of the present invention for the dry sprinkler head to comprise a vial which will expand and break based upon the temperature of the surrounding environment. It is an object of the present invention for the rod or actuator linkage to be held in place by the groove of the ball and keep the dry sprinkler head in the closed position until the vial breaks and the rod moves forward allowing the ball to rotate 90° to the open position.

It is an object of the present invention for the vial to sit in a bulb seat. The rod is attached to the bulb seat. The vial breaks which pushes on the bulb seat, and moves the rod which releases the ball to rotate 90° to an open position.

It is an object of the present invention for there to be no tension on the rod. It is an object of the present invention for there to be virtually no compression.

It is an object of the present invention for the seat design to comprise an enlarged end assembly, a brass inlet ring where the water enters, and a cartridge. The cartridge is assembled first and threaded into the base. This allows the ball to float in the cartridge.

It is an object of the present invention for the ball to be a chrome plated brass ball.

It is an object of the present invention for the seat assembly to comprise a brass inlet ring, followed by Teflon (PTFE) seat. It is an object of the present invention for the seat to be a beveled seat that the ball sits in and is cradled in. After the first Teflon seat, it is followed by the ball and then a second Teflon (PTFE) seat which is then followed by the brass internal ring.

It is an object of the present invention for the ball to be dielectrically insulated from the surrounding metal components to eliminate corrosion caused by dissimilar metals in physical contact with one another.

It is an object of the present invention for the ball to be held by a trunion, two screws, which allows the ball to move. System pressure (water or air) pushes the ball into the seat, producing an air-tight seal. This design allows the ball to move slightly as system pressures fluctuate, thus reducing the chances of the ball fusing to the seat over extended periods of time in service.

In the prior art, all dry sprinklers protrude the seat into the adjoining fitting. If there is any condensation, it does not sit in the seat.

It is an object of the present invention for the brass inlet ring to be tapered. It is an object of the present invention for the ball is tapered and shed any condensation. The dry sprinkler ball can be threaded into a tee, elbow, or coupling. In the prior art, the dry sprinkler head can only be threaded into a tee.

It is an object of the present invention for the rod of the dry sprinkler head to be a fully adjustable assembly. The piping and the dry sprinklers are pitched to a condensation drain. In the prior art, all dry sprinkler heads are custom made. Since the rod of the present invention is not under tremendous pressure, it can be made adjustable.

The present invention relates to a dry sprinkler comprising: an outer casing, and an inner casing; a head section comprising a deflector a compression screw, a frame having a bulb which is in a bulb seat. An end assembly is comprised of a ball set assembly, and a trunion. The ball set assembly comprises a ball which has a groove or notch, the groove having a rod or actuation linkage resting in it. The trunion has a ball within it.

It is an object of the present invention for the ball to be in a loaded position, with the seat sealed, and having no flow of water.

It is an object of the present invention for the dry sprinkler to have a ball in released position, with the seat open, and having water flowing.

It is an object of the present invention for the dry sprinkler to comprise an end assembly having a ball within PTFE seats which are then within a brass inlet ring and brass internal ring.

The present invention relates to a dry sprinkler comprising: a rod guide, a galvanized pipe, a stainless steel rod or actuator; and an end assembly comprising an internal ring, torsion spring and pipe. The end assembly further comprises brass inlet band, PTFE seat, ball, and ball sealing assembly. The sprinkler end comprises a deflector, a compression screw, a frame, and a bulb in a bulb seat.

In the prior art, design utilize a spring assembly under heavy compression to compensate for the full spectrum of system pressures, often resulting in seat release failure. The present invention utilizes a free-floating chrome plated brass ball/PTFE configuration eliminating metal on metal contact and providing a virtually fail safe assembly.

In the prior art designs resulted in significant internal flow restrictions. The present invention provides an assembly which is virtually full, unrestricted internal flow. It provides a potential hydraulic advantage over current designs with UL/FN/MFPA design criteria.

In the prior art, dry sprinklers require to be coupled extensively into tee fittings to compensate for large, squared seat protrusions. The present invention allows universal mating fitting instillation resulting in faster installations without concern of fitting obstruction.

In the prior art, dry sprinkler designs are fixed and rigid. The present invention allows for inventory reduction, lead time reduction, in-field engineering reduction, and labor and installation savings.

### BRIEF DESCRIPTION OF DRAWINGS

FIG. 1 illustrates a side internal view of the dry sprinkler head.

FIG. 2 illustrates the loaded position of the trunion.

FIG. 3 shows the released position of the trunion.

FIG. 4 shows an end assembly view of the dry sprinkler head.

FIG. 5 shows a side view of the pipe section of the dry sprinkler head.

FIG. 6 shows a front view of the end assembly of the dry sprinkler head.

FIG. 7 shows a sectional view of the end assembly of the dry sprinkler head.

FIG. 8 shows a rear view of the end assembly of the dry sprinkler head.

FIG. 9 shows a section view of the seat assembly of the dry sprinkler head.

FIG. 10 shows a plan view of the seat assembly of the dry sprinkler head.

FIG. 11 shows a plan view of the ball of the dry sprinkler head.

FIG. 11a shows a plan view of the ball of the dry sprinkler head.

FIG. 12 shows a side view of the ball of the dry sprinkler head.

FIG. 13 shows a plan view of the internal ring of the dry sprinkler head.

FIG. 14 shows a sectional view of the internal ring of the dry sprinkler head.

FIG. 15 shows a side view of the internal ring of the dry sprinkler head.

### DETAILED DESCRIPTION OF THE INVENTION

A dry sprinkler having a fail safe seat. The device comprises a ball with an orifice through it. The ball is placed in an end assembly. In an embodiment the end assembly has an inlet ring. In an embodiment, the inlet ring is made of brass. The ball replaces the compression seat and spring assembly of the prior art.

In an embodiment, there is a groove in the ball. The groove holds a rod or actuator linkage in place. In an embodiment, the dry sprinkler head comprises a vial which expands and breaks based upon the temperature of the surrounding environment. In an embodiment, the rod or actuator linkage is held in place by the groove of the ball which keeps the dry sprinkler head in the closed position until the vial breaks and the rod moves forward, allowing the ball to rotate 90° to the open position.

In an embodiment, the vial sits in a bulb seat. The rod is attached to the bulb seat. The vial breaks which pushes on the bulb seat, and moves the rod which releases the ball to rotate 90° to an open position.

In an embodiment, there is no tension on the rod. In an embodiment, there is virtually no compression.

In an embodiment, the seat design comprises an end assembly, comprising a brass inlet ring where the water enters, and a cartridge. The cartridge is assembled first and threaded into the base. This allows the ball to float in the cartridge.

In an embodiment, the ball is a chrome plated brass ball.

In an embodiment, the seat assembly comprises a brass inlet ring, followed by Teflon (PTFE) seat. In an embodiment, the seat is a beveled seat that the ball sits in and is cradled in. After the first Teflon seat, it is followed by the ball and then a second Teflon (PTFE) seat which is then followed by the brass internal ring.

In an embodiment, the ball is dielectrically insulated from the surrounding metal components to eliminate corrosion caused by dissimilar metals in physical contact with one another.

In an embodiment, the ball is held by a trunion, two screws, which allows the ball to move. System pressure (water or air) pushes the ball into the seat producing an air-tight seat. The ball is allowed to move slightly as system pressure fluctuates.

In the prior art, all dry sprinklers protrude the seat into the adjoining fitting. If there is any condensation, it does not sit in the seat.

&In an embodiment, the brass inlet ring is tapered. Because the ball is tapered it sheds any condensation. The dry sprinkler can be threaded into a tee, elbow or coupling.

In an embodiment, the rod of the dry sprinkler head is a fully adjustable assembly. The piping and the dry sprinklers are pitched to a condensation drain. In the prior art, all dry sprinkler heads are custom made. Since the rod of the present invention is not under tremendous pressure, it can be made adjustable.

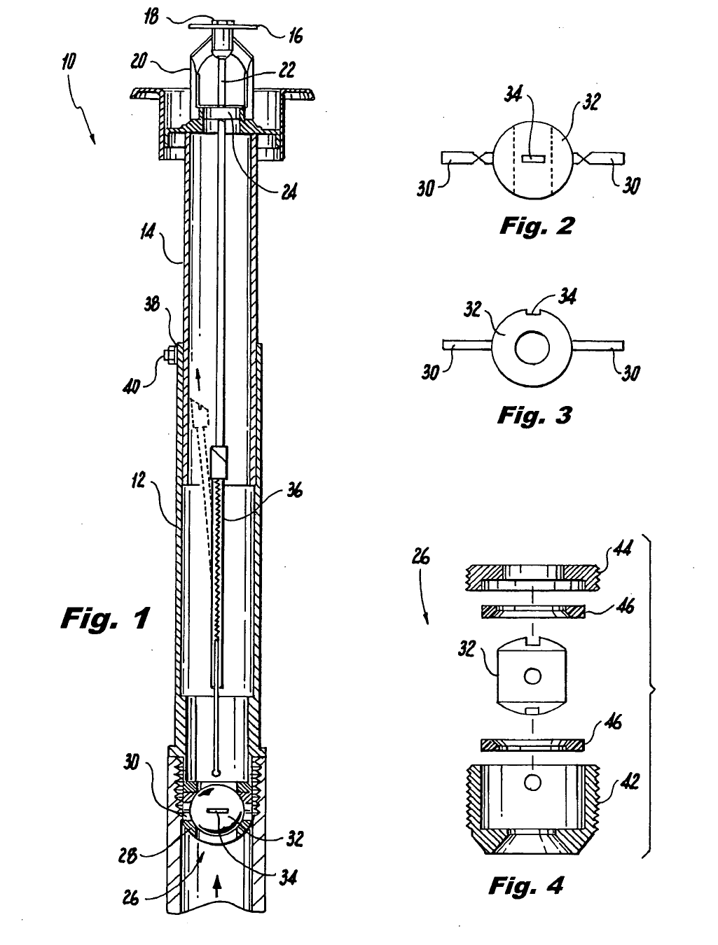

FIG. 1 shows a dry sprinkler 10 having an outer casing 12 and an inner casing 14. The sprinkler 10 has a head section having a deflector 16 and a compression screw 18. The head section further comprises a frame 20 having a bulb 22 which is in a bulb seat 24. Dry sprinkler 10 further comprises an end assembly 26 which is comprised of a ball set assembly 28, and an integral trunion spring assembly 30 which holds and loads the ball. The ball set assembly has a ball 32 which has a groove 34. The groove allows a rod or actuation linkage 36 to rest in it. The actuator linkage 36 is adjustable in this embodiment. The dry sprinkler further comprises a set screw 40 and a continuous 0 ring sealant 38.

FIG. 2 shows the twisted spring trunion 30 having the ball 32 within it and the groove 34. FIG. 2 shows the ball 32 in the loaded position, with the seat sealed, and having no flow of water.

FIG. 3 shows the non-twisted trunion spring assembly 30 having the ball 32 within it and the groove 34. FIG. 3 shows the ball 32 in the released position, with the seat open, and having the water flowing.

FIGS. 2 and 3 illustrate an integral trunion spring. This eliminates the need for separate screws and tortion springs as it consolidates each feature (spring, trunion) into one component per side.

FIG. 4 shows the end assembly 26. The end assembly 26 has the ball 32 within the PTFE seats 46 which are then within the brass inlet ring 42 and brass internal ring 44. This embodiment shows in conjunction with FIG. 11, 11a and FIG. 12, the torsion springs and the screws which hold the ball in place.

FIG. 5 shows the pipe section view of the device 100. Device 100 comprises a rod guide 102, a galvanized pipe 104 and a stainless steel rod or actuator 106. The end assembly 108 comprises internal ring 110, torsion spring 112 and pipe threads 114 and 116. The end assembly 108 further comprises brass inlet band 118, PTFE seat 120 and brass ball sealing assembly 122. The sprinkler end of the device comprises a deflector 124, a compression screw 126, and frame 128, bulb 130 in a bulb seat 132. This embodiment shows the non-adjustable dry sprinkler head having fixed screws and trunion springs.

FIG. 6 shows an enlarged front view of inlet ring 42 having brass inlet band 140.

FIG. 7 shows a sectional view of the inlet ring.

FIG. 8 shows the rear view of the inlet ring, which has a tap for set screw 142.

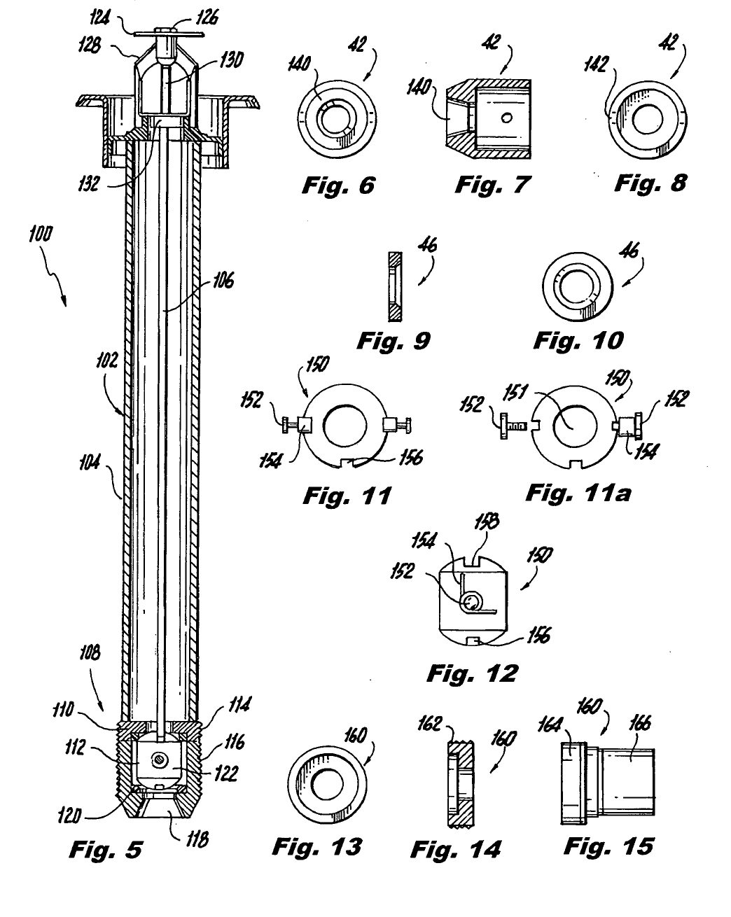

FIG. 9 shows a section view of the seat 46.

FIG. 10 shows the plan view of the seat 46.

FIG. 11 shows an enlarged view of the ball 150. The ball 150 is chrome plated brass. The ball 150 comprises a screw 152 and torsion spring 154 located on each side of the ball 150. The ball also comprises a tap 156.

FIG. 11a shows the ball 150 having an orifice 151. There is a screw 152 without the torsion spring on the left side, and a screw 152 with the torsion spring 154 on the right side.

FIG. 12 shows an enlarged side view of the ball 150. The ball 150 comprises a screw 152, torsion spring 154, a tap 156 and a groove 158.

FIG. 13 shows a plan view of the internal ring 160.

FIG. 14 shows a section view of the internal ring 160 having a thread 162.

FIG. 15 shows the internal ring 160 having a stainless steel plate 164 and a brass bulb seat 166.

1. A dry sprinkler comprising:
a device with an orifice through it;
said device placed in a seat;
said device having a groove or notch;
a rod or actuator linkage;
said rod or actuator linkage being held in place by said groove or notch;
a vial which expands and breaks based upon temperature of surrounding environment;
said vial sits in a bulb seat.
rod is attached to said bulb seat.

2. The dry sprinkler of claim 1 wherein said seat comprises an end assembly.

3. The dry sprinkler of claim 2 wherein said end assembly comprises an inlet ring and a cartridge.

4. The dry sprinkler of claim 3 wherein said inlet ring comprises brass.

5. The dry sprinkler of claim 1 wherein said device is a ball.

6. The dry sprinkler of claim 1 wherein said rod or actuator linkage is held in place by said groove or notch in said device which keeps dry sprinkler head in closed position until said vial breaks and said rod moves forward rotating said device 90° to open position.

7. The dry sprinkler of claim 1 wherein there is no tension on said rod.

8. The dry sprinkler of claim 1 wherein there is virtually no compression.

9. The dry sprinkler of claim 5 wherein said ball is a chrome plated brass ball.

10. The dry sprinkler of claim 3, wherein said cartridge is assembled first and threaded into said end assembly

11. The dry sprinkler of claim 3 wherein said device floats in said cartridge.

12. The dry sprinkler of claim 1 wherein said seat is a beveled seat that said device sits in and is cradled in.

13. The dry sprinkler of claim 1 wherein said seat comprises a brass inlet ring followed by Teflon (PTFE) seat, followed by said device followed by a second Teflon seat, followed by brass internal ring.

14. The dry sprinkler of claim 1 wherein said device never touches metal.

15. The dry sprinkler of claim 1 wherein said device is held by a trunion which allows said device to move.

16. The dry sprinkler head of claim 1 wherein water pressure pushes said device into said seat.

17. The dry sprinkler of claim 1 wherein said device moves as pressure changes.

18. The dry sprinkler of claim 1 wherein said inlet ring is tapered.

19. The dry sprinkler of claim 1 wherein said device is tapered

20. The dry sprinkler of claim 1 wherein said dry sprinkler comprises an adjustable assembly.

21. A dry sprinkler comprising:
a head section comprising a deflector a compression screw, a frame having a bulb which is in a bulb seat;
an end assembly which is comprised of a ball seat assembly, and a trunion;
said ball seat assembly having ball which has a groove or notch;
groove having a rod or actuation linkage resting in it;
trunion having said ball within it.

22. The dry sprinkler of claim 2.1 wherein said ball is in loaded position, with said seat sealed, and having no flow of water.

23. The dry sprinkler of claim 21 wherein ball in released position, with said seat open, and having water flowing.

24. The dry sprinkler of claim 21 wherein said end assembly has ball within PTFE seats which are then within a brass inlet ring and brass internal ring.

25. A dry sprinkler comprising:
a rod guide,
a galvanized pipe,
a stainless steel rod or actuator;
an end assembly comprising an internal ring, torsion spring and pipe threads;
said end assembly further comprises brass inlet band, PTFE seat, ball, and ball sealing assembly;
sprinkler end comprising a deflector, a compression screw, a frame, and a bulb in a bulb seat.
